(19) United States
(12) Patent Application Publication
(10) Pub. No.: US 2016/0145145 A1
(43) Pub. Date: May 26, 2016

(54) OPTICAL FIBER BASE MATERIAL DRAWING METHOD

(71) Applicant: Shin-Etsu Chemical Co., Ltd., Tokyo (JP)

(72) Inventor: Hideki FUJII, Ibaraki (JP)

(21) Appl. No.: 14/944,206

(22) Filed: Nov. 17, 2015

(30) Foreign Application Priority Data
Nov. 20, 2014 (JP) 2014-235246

(51) Int. Cl. C03B 37/025

(52) U.S. Cl. CPC C03B 37/025

(57) ABSTRACT

An optical fiber base material drawing method for forming a constricted shape having a reduced diameter along a longitudinal direction of the optical fiber base material in a predetermined constricted shape segment in the longitudinal direction of the optical fiber base material at one end of the optical fiber base material, including: starting heating of the optical fiber base material with a heating source from a heating start position positioned in the constricted shape segment; then heating the optical fiber base material with the heating source in another segment having a predetermined length adjacent to the constricted shape segment; then returning the heating source to the heating start position and softening the optical fiber base material in the constricted shape segment by heating the optical fiber base material; and then forming the constricted shape by reducing the diameter of the optical fiber base material by applying a tensile force thereto.

The contents of the following Japanese patent application is incorporated herein by reference:

NO. 2014-235246 filed on Nov. 20, 2014.

### BACKGROUND

1. Technical Field

The present invention relates to a drawing method of an optical fiber base material.

2. Related Art

An optical fiber base material undergoes primary elongation so that its outer shape conforms to a drawing machine, using an elongation apparatus that includes an electric furnace, and then both ends or one end is machined to have a constricted shape suitable for drawing, using a glass lathe. The constricted shape is formed by drawing. After this the optical fiber base material is finished by flame polishing the entire surface thereof. When drawing the optical fiber from the optical fiber base material, a dummy glass rod for hanging is fused to one end of the optical fiber base material, and the optical fiber is drawn forth from the thin diameter portion formed by the drawing.

If there is an irregularity in the surface state caused by a scratch or the adhesion of impurities on the surface of the optical fiber base material, when drawing the optical fiber, there are various negative effects such as breaking, outer diameter fluctuation, and degradation of the characteristics. Therefore, the surface of the optical fiber base material is preferably smooth and has few impurities.

However, there is a trend in recent years for the outer diameter of the optical fiber base material to become larger, and this has led to an increase in the heating amount provided by the preheating before the drawing and an increase in the expended gas amount and work time. As a result, a large amount of glass microparticles known as a silica cloud adheres to a region on the surface of the optical fiber base material near the region heated by the flame, and this worsens the surface state of the optical fiber base material.

### SUMMARY

According to a first aspect of the present invention, provided is an optical fiber base material drawing method for forming a constricted shape having a reduced diameter along a longitudinal direction of the optical fiber base material in a predetermined constricted shape segment in the longitudinal direction of the optical fiber base material at one end of the optical fiber base material. The method comprise starting heating of the optical fiber base material with a heating source from a heating start position that is positioned in the constricted shape segment; then heating the optical fiber base material with the heating source in another segment having a predetermined length that is adjacent to the constricted shape segment; then returning the heating source to the heating start position and softening the optical fiber base material in the constricted shape segment by heating the optical fiber base material; and then forming the constricted shape by reducing the diameter of the optical fiber base material by applying a tensile force to the optical fiber base material.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic view of a stage for preheating the optical fiber base material 10.

FIG. 2 is a schematic view of a stage for flame polishing the optical fiber base material 10.

FIG. 3 is a schematic view of a stage for preheating the optical fiber base material 10.

FIG. 4 is a schematic view of a stage for starting drawing of the optical fiber base material 10.

FIG. 5 is a schematic view of a stage after the drawing of the optical fiber base material 10.

FIG. 6 is a schematic view of a stage for flame polishing the optical fiber base material 10.

FIG. 7 is a schematic view of a stage for thermal cutting of the optical fiber base material 10.

FIG. 8 is a schematic view of a stage for preheating the optical fiber base material 10.

FIG. 9 is a schematic view of a stage for starting drawing of the optical fiber base material 10.

FIG. 10 is a schematic view of a stage for starting drawing of the optical fiber base material 10.

FIG. 11 is a schematic view of a stage for flame polishing the optical fiber base material 10.

FIG. 12 is a schematic view of a stage for thermal cutting of the optical fiber base material 10.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

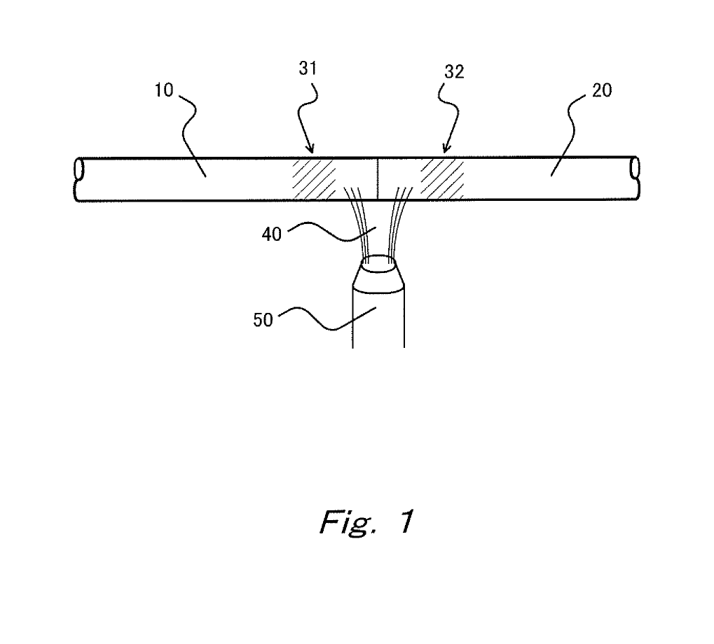

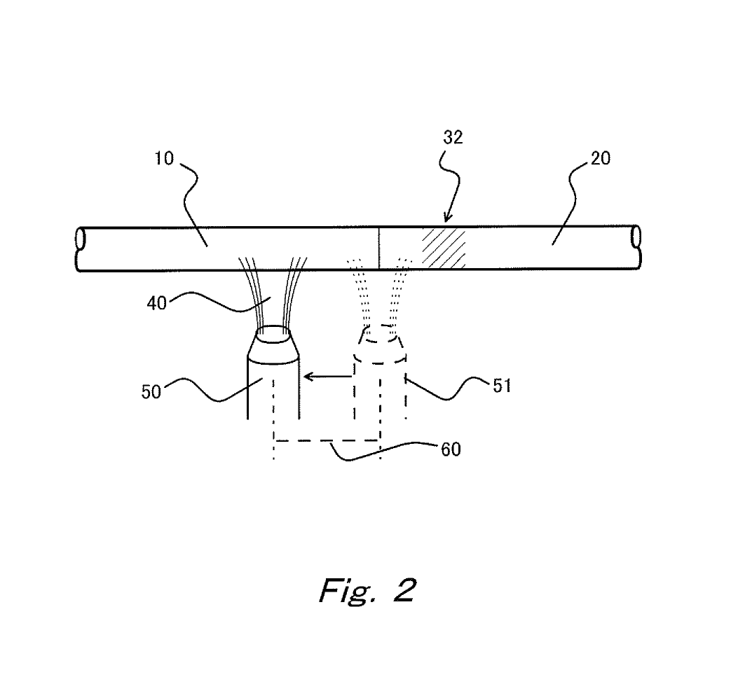

FIGS. 1 to 7 are schematic views of an optical fiber base material drawing method according to an embodiment of the present invention, shown in multiple stages. In FIGS. 2 to 7, components that are the same as shown in FIG. 1 are given the same reference numerals, and redundant descriptions are omitted.

First, as shown in FIG. 1, an optical fiber base material 10 connected to one end of a dummy rod 20 made of quartz glass is gripped by a chuck of a glass lathe. Next, a position where the constricted shape is to be formed is set near the connection portion between the optical fiber base material 10 and the dummy rod 20, and initial preheating begins from this position. In the example shown in the drawings, the initial preheating begins at a starting point within the segment to be drawn that is on the side of the connection portion between the optical fiber base material 10 and the dummy rod 20. During the preheating, the optical fiber base material 10 is heated through contact with a flame 40 emitted from a burner 50.

As shown in FIG. 1, silica clouds 31 and 32 stick to the circumferential edge of the region contacted by the flame 40 used for the initial preheating on the surface of the optical fiber base material 10. The decomposition reaction of the quartz glass at a high temperature is complicated, but can essentially be represented as SiO₂ decomposing into SiO and O₂, as shown by Expression 1 below.

2SiO₂→2SiO+O₂ Expression 1:

Furthermore, the evaporated SiO causes a hydrolytic reaction in the atmosphere, as shown by Expression 2 below, to again become SiO₂ and be deposited on a region with a low temperature near the heated portion as glass microparticles referred to as a silica cloud.

SiO+H₂O→SiO₂+H₂ Expression 2:

The amount of the silica clouds 31 and 32 adhering to the optical fiber base material 10 as a result of the fusion of the dummy rod 20 and the initial preheating increases according to increases in the time and the amount of gas used for the heating. However, as shown in FIG. 2, the adhered silica clouds 31 and 32 can be removed by partial flame polishing, i.e. applying the flame 40 to the surface of the optical fiber base material 10 across a predetermined movement distance 60 of the burner 50 by moving the burner 50 along the optical fiber base material 10 from a start position 51 of the preheating.

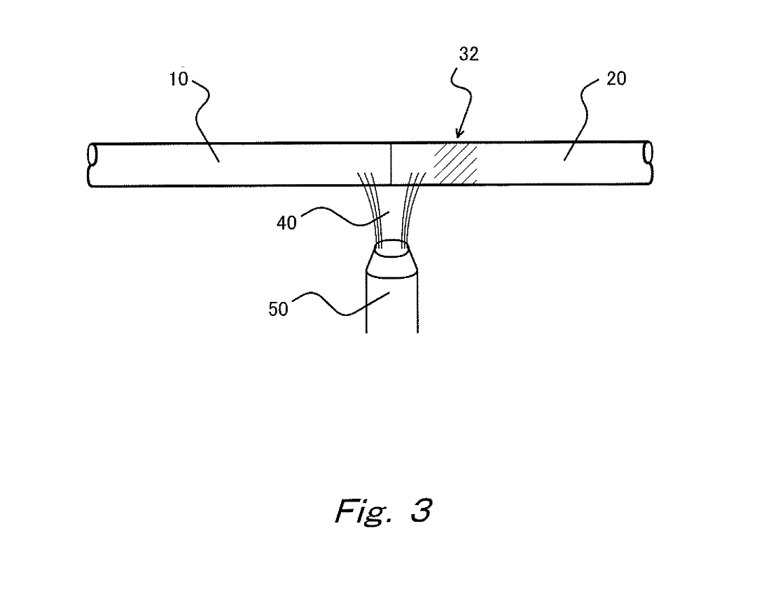

During the partial flame polishing, the movement direction of the burner 50 is reversed when the burner 50 has moved the predetermined movement distance 60, and the burner 50 then returns to the preheating start position 51, as shown in FIG. 3. In this way, the silica clouds, impurities, and the like on the surface of the optical fiber base material 10 can be removed.

The movement distance 60 of the burner 50 is preferably a range that is no less than 1 time and no greater than 3 times the outer diameter of the optical fiber base material 10. The movement distance 60 of the burner 50 is more preferably no less than 1.5 times and no greater than 2 times the outer diameter of the optical fiber base material 10. If the movement distance 60 of the burner 50 is less than 1 time the outer diameter of the optical fiber base material 10, there are cases where the silica cloud 31 remains. If the movement distance 60 of the burner 50 is greater than 3 times the outer diameter of the optical fiber base material 10, the flame polishing continues to regions where the silica cloud 31 is not adhered, and therefore the energy efficiency is decreased.

In the preheating described above, the movement speed of the burner 50 while moving the movement distance 60 from the preheating start position 51, i.e. the forward travel, is preferably a speed that does not cause thermal warping of the optical fiber base material 10. Furthermore, the movement speed of the burner 50 while returning to the start position 51 after having moved the movement distance 60, i.e. the return travel, may be greater than the movement speed of the burner 50 while moving the movement distance 60 from the preheating start position 51, i.e. the forward travel. The optical fiber base material 10 is already heated during the forward travel, and therefore it is difficult for thermal warping to occur due to the heating during the return travel of the burner 50. Accordingly, the movement speed of the burner 50 can be increased to shorten the work time required for the drawing of the optical fiber base material 10.

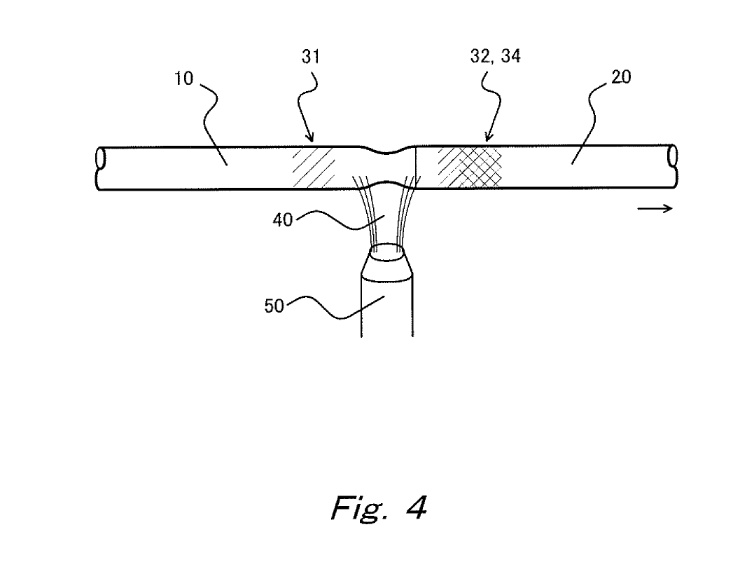

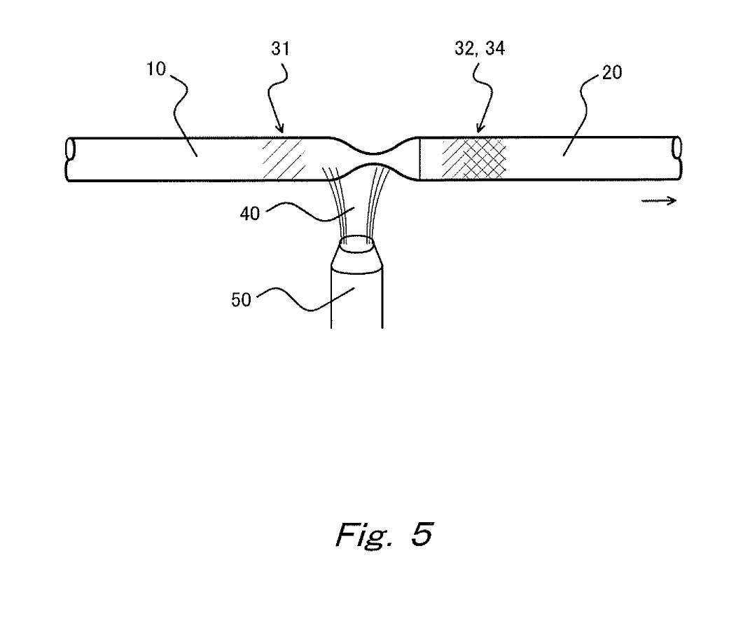

Next, during the drawing of the optical fiber base material 10, as shown in FIG. 4, the burner 50 that has returned to the start position 51 performs heating in order to soften the position where the constricted shape of the optical fiber base material 10 is to be formed. Furthermore, as shown in FIGS. 4 and 5, when the optical fiber base material 10 is softened, a tensile force is applied to the optical fiber base material 10 by increasing the space between the ends of the heated portion while adjusting the gas amount of the burner, thereby gradually reducing the diameter of the portion that has been softened by heating. In this way, the constricted shape is formed in the optical fiber base material 10.

During this stage of heating as well, silica clouds 33 and 34 are generated and adhere to the optical fiber base material 10 and the dummy rod 20. However, since the optical fiber base material 10 has already been heated by the initial preheating, the heating time during this stage is short. Accordingly, the amount of the silica clouds 33 and 34 generated in this stage is low.

A position near the position where the constricted shape is formed in the optical fiber base material 10 has already reached a high temperature due to the initial preheating and the flame polishing performed previously. As described above, the reaction by which SiO₂ is deposited according to the hydrolysis of SiO occurs in a region with low temperature. Therefore, near the position where the constricted shape is formed, a large percentage of SiO is expelled without causing SiO₂ deposition, thereby restricting the generation of the silica clouds 33 and 34.

Furthermore, it is difficult for impurities to adhere to the surface of the optical fiber base material 10 that has already become smooth due to the flame polishing. In the same way that the deposition of the silica clouds 33 and 34 is restricted, it is assumed that deposition of silicate compound impurities of metal components, which are impurities, is difficult in regions with high temperature. Furthermore, it is assumed that decreasing the surface area of the optical fiber base material 10 that has become smooth due to the flame polishing will also have an effect.

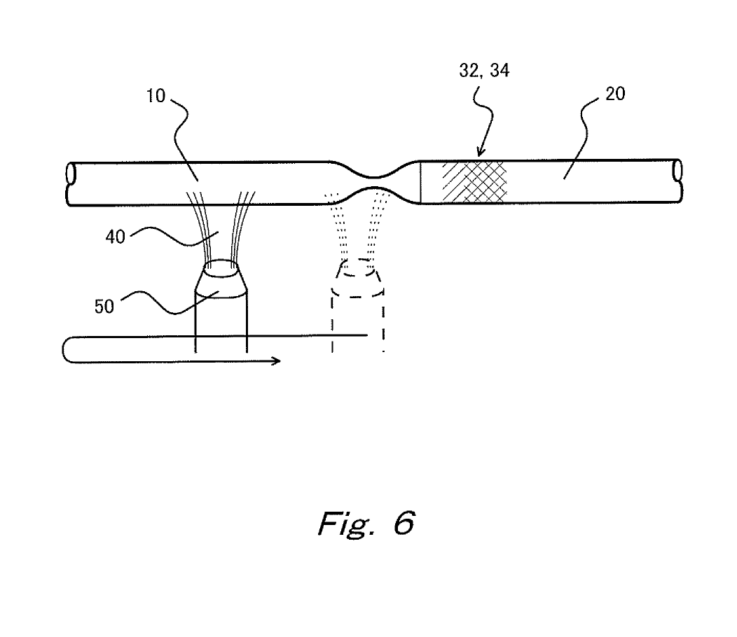

The optical fiber base material 10 in which the constricted shape is formed as described above has its entire surface flame polished and finished, by moving the burner 50 along the optical fiber base material 10, as shown in FIG. 6. In this way, the silica cloud 33 adhered to the surface of the optical fiber base material 10 is easily and reliably removed by the polishing.

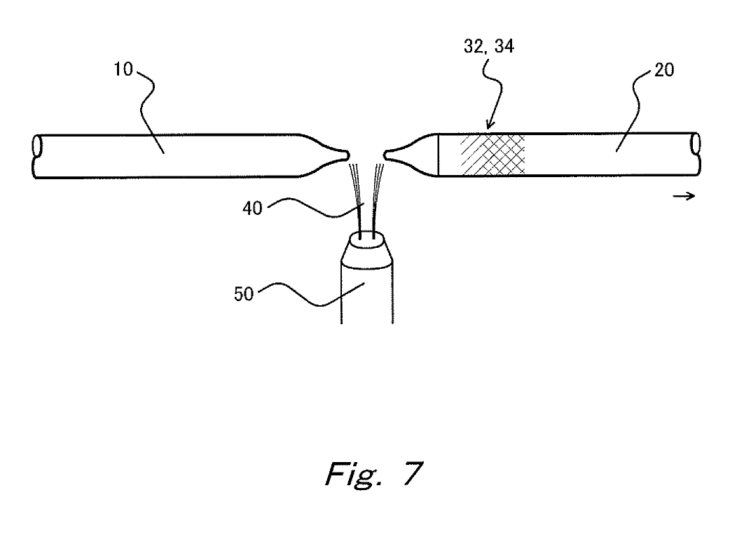

Furthermore, as shown in FIG. 7, at the constricted shape of the optical fiber base material 10, a region near the portion having the smallest diameter is further heated to sever the dummy rod 20 from the optical fiber base material 10. The optical fiber base material 10 having the constricted shape obtained in this manner prevents unevenness in the optical fiber base material 10 caused by the adherence of the silica clouds 33 and 34 and impurities. Furthermore, by performing flame polishing across the entire length of the optical fiber base material 10, warping of the optical fiber base material 10 is reduced. Therefore, the quality of the optical fiber base material 10 is improved, and the yield for the optical fiber is also improved.

### FIRST MANUFACTURING EXAMPLE

An optical fiber base material 10 was drawn using a glass lathe including a burner 50. The burner 50 was an oxyhydrogen flame burner including an oxygen nozzle that supplies oxygen as a combustion supporting gas. The drawn optical fiber base material had an average diameter of 85 mm, was connected to dummy rods 20 at both ends, and was set in a glass lathe via the dummy rods 20.

A position 20 mm toward the base material side from a connection portion between the optical fiber base material and a dummy rod was set as the preheating start position 51. The initial flame polishing was performed with the movement speed of the burner 50 set to 30 mm/min in a direction toward the optical fiber base material 10 side. The movement direction was reversed when the movement distance of the burner 50 reached 150 mm, and the burner 50 returned to the preheating start position 51 at a speed of 60 mm/min, which is double the movement speed of the forward travel.

Next, the optical fiber base material 10 was preheated from the start position 51 in order to form the constricted shape, and after the segment to have a reduced diameter was sufficiently heated, the diameter of the optical fiber base material 10 was reduced by increasing the space between the ends of the segment to have the reduced diameter. In this way, the constricted shape was formed in the optical fiber base material 10. A constricted shape was also formed at the opposite end of the optical fiber base material 10 using the same process, and then the entire optical fiber base material 10 was flame polished, the thin diameter portions of the constricted shapes were thermally cut, and the optical fiber base material 10 was removed from the glass lathe.

With the conditions described above, the drawing process was performed on 100 optical fiber base materials to form the constricted shapes, and an investigation of the finished surfaces was performed. Unevenness that is assumed to be caused by the silica clouds 33 and 34 was found on the end surfaces of 2 of the 100 optical fiber base materials. Accordingly, the rate of unevenness of optical fiber base materials 10 manufactured with this method was 2%.

### SECOND MANUFACTURING EXAMPLE

Using the same method and conditions as in the first manufacturing example, drawing was performed on 100 optical fiber base materials 10 having an average diameter of 120 mm. Upon investigating the finished surfaces of the resulting optical fiber base materials 10 having constricted shapes, unevenness that is assumed to be caused by the silica clouds was found on the end surface of 1 of the 100 optical fiber base materials. Accordingly, the rate of unevenness was 1%.

### COMPARATIVE EXAMPLE

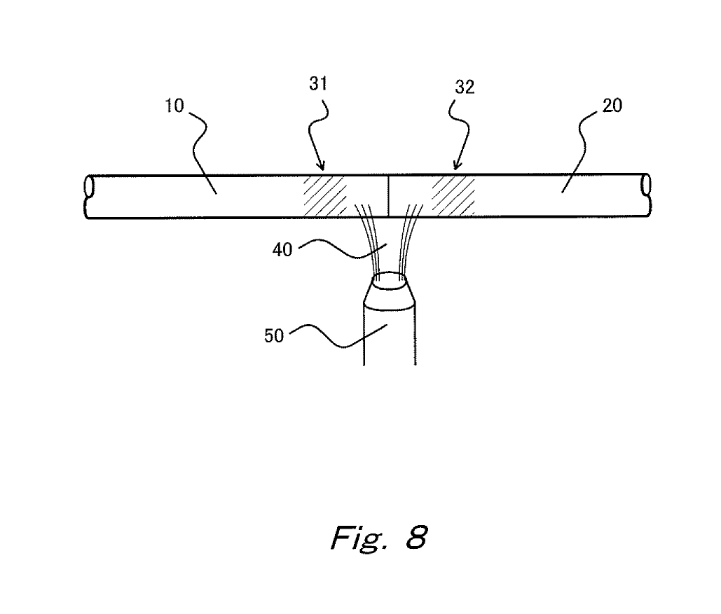

FIGS. 8 to 12 show each step in the drawing method of an optical fiber base material 10 as a comparative example. In these drawings, components that are the same as components shown in FIGS. 1 to 7 are given the same reference numerals, and redundant descriptions are omitted.

First, as shown in FIG. 8, an optical fiber base material 10 connected to a dummy rod 20 made of quartz glass is gripped by a glass lathe, and preheating is begun from a position where the constricted shape is to be formed that is set near the connection portion between the optical fiber base material 10 and the dummy rod 20.

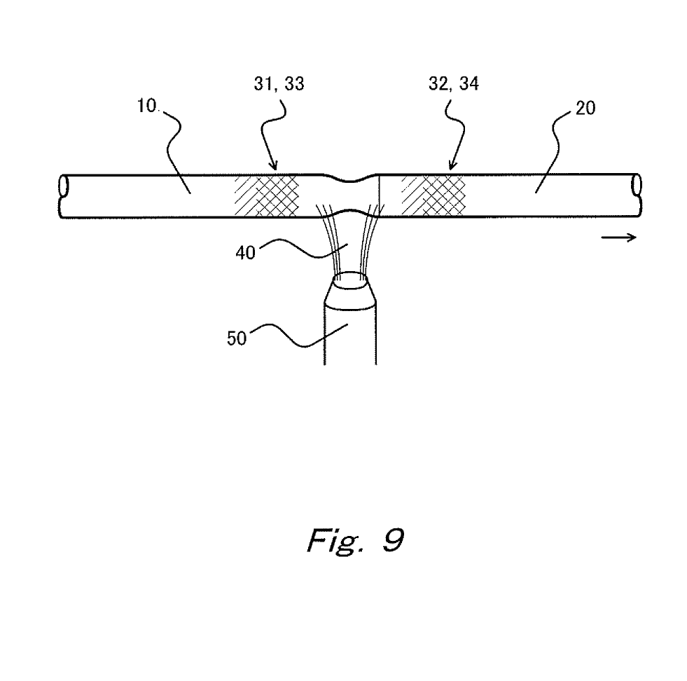

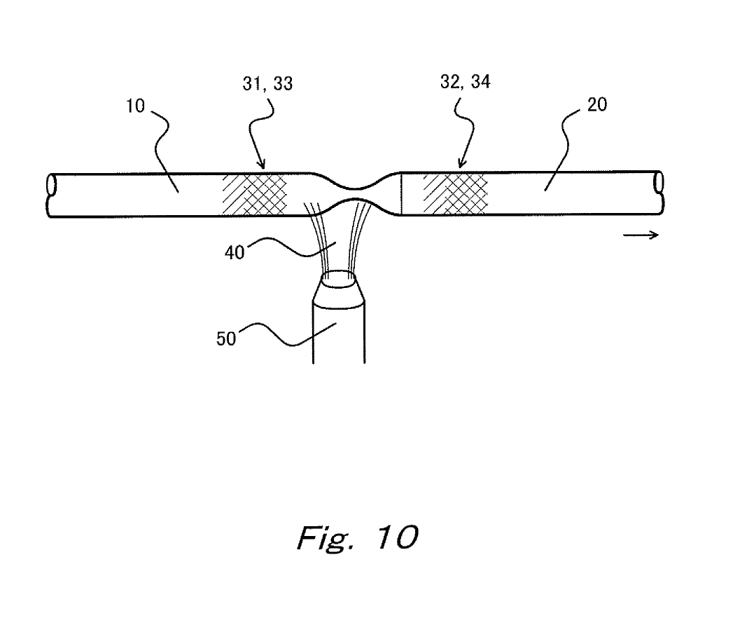

Next, as shown in FIG. 9, the position where the constricted shape is to be formed in the optical fiber base material 10 is heated and softened by the burner 50. Next, as shown in FIGS. 9 and 10, a tensile force is applied to the portion of the optical fiber base material 10 softened by the heating, by increasing the space between the ends of the heated portion while adjusting the gas amount of the burner, thereby gradually reducing the diameter. In this way, the constricted shape is formed in the optical fiber base material 10.

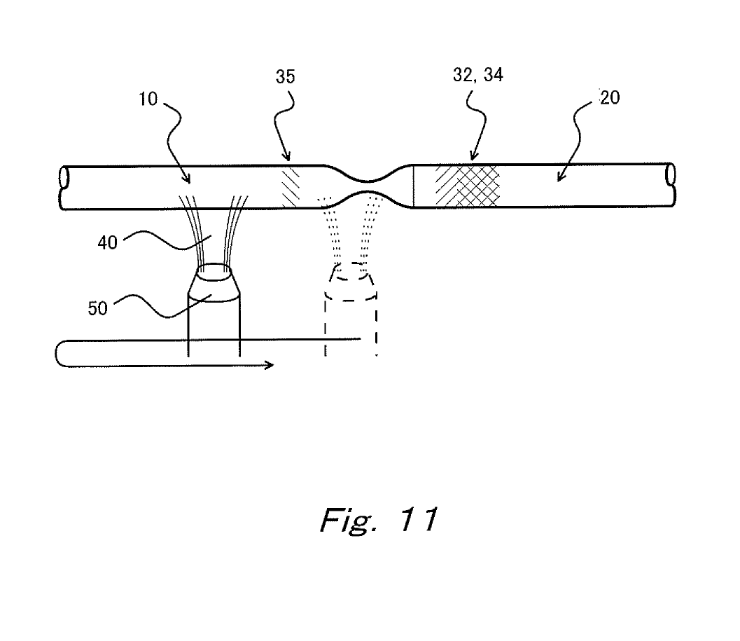

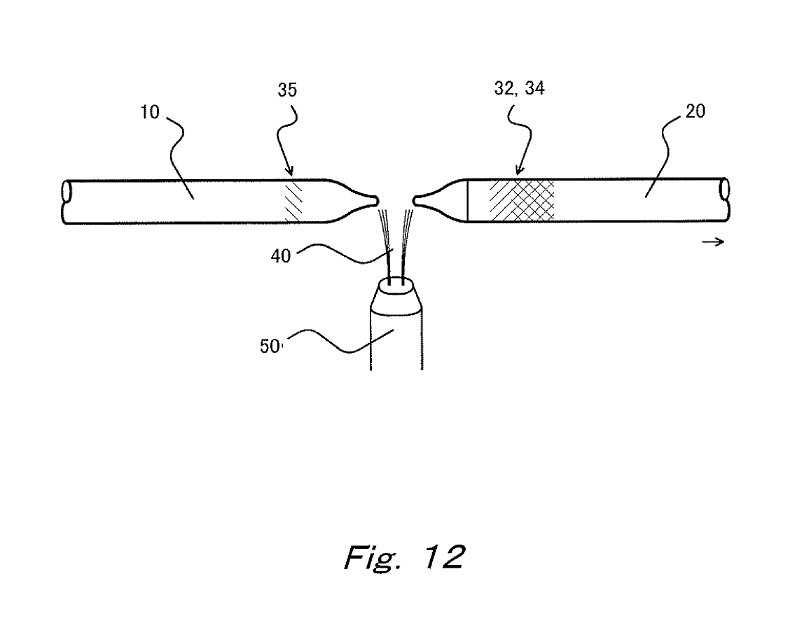

Next, as shown in FIG. 11, the optical fiber base material 10 is flame polished and finished by moving the burner 50 along the optical fiber base material 10 such that the flame 40 of the burner 50 contacts the entire surface of the optical fiber base material 10. Furthermore, as shown in FIG. 12, a region near the portion with the smallest diameter in the constricted shape of the optical fiber base material 10 is further heated, thereby severing the optical fiber base material 10 from the dummy rod 20.

In this way, the optical fiber base material 10 having a constricted shape is manufactured. As shown in FIG. 12, even after the flame polishing, there are cases where deposition of a silica cloud 35 is found on the surface of the optical fiber base material 10.

According to the process described above, using a glass lathe including a burner 50 with the same specifications as the burner used for the drawing in the first and second embodiments, 100 optical fiber base materials 10 connected to dummy rods 20 at both ends and having an average diameter of 85 mm, which is the same diameter as in the first embodiment, were drawn. Upon investigating the finished surfaces of the resulting optical fiber base materials 10 having the constricted shapes, unevenness assumed to be caused by the silica clouds was found on the end surfaces of 10 of the 100 optical fiber base materials, indicating an unevenness rate of 10% and a low yield.

In this way, during the drawing of an optical fiber base material 10 with a flame burner as a heating source using a glass lathe, by flame polishing a portion of the optical fiber base material 10 on the product side from the preheating position after the preheating and before beginning the process to reduce the diameter of the optical fiber base material 10, it is possible to remove silica clouds, impurities, and the like, and to restrict irregularities in the surface state caused by unevenness or adherence of impurities on the base material surface during the process to reduce the diameter. As a result, it is possible to improve the yield for the drawing of the optical fiber base material, and to improve the producibility of the optical fiber.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An optical fiber base material drawing method for forming a constricted shape having a reduced diameter along a longitudinal direction of the optical fiber base material in a predetermined constricted shape segment in the longitudinal direction of the optical fiber base material at one end of the optical fiber base material, the method comprising:
starting heating of the optical fiber base material with a heating source from a heating start position that is positioned in the constricted shape segment;
then heating the optical fiber base material with the heating source in another segment having a predetermined length that is adjacent to the constricted shape segment;
then returning the heating source to the heating start position and softening the optical fiber base material in the constricted shape segment by heating the optical fiber base material; and
then forming the constricted shape by reducing the diameter of the optical fiber base material by applying a tensile force to the optical fiber base material.

2. The optical fiber base material drawing method according to claim 1, wherein
the heating source flame polishes the optical fiber base material in the other segment having a length that is no less than 1 time and no greater than 3 times an outer diameter of the optical fiber base material.

3. The optical fiber base material drawing method according to claim 1, wherein
the heating source flame polishes the optical fiber base material while moving along the optical fiber base material from one end of the other segment that forms a border with the constricted shape segment.

4. The optical fiber base material drawing method according to claim 3, wherein
the heating source flame polishes the optical fiber base material while moving along the optical fiber base material from another end of the other segment toward the constricted shape segment.

5. The optical fiber base material drawing method according to claim 4, wherein
the heating source moves with a higher moving speed when moving from the other end toward the one end than when moving from the one end toward the other end.

6. The optical fiber base material drawing method according to claim 1, wherein
the heating source includes a burner for heating the optical fiber base material set in a glass lathe.

7. The optical fiber base material drawing method according to claim 6, wherein
the heating source heats the optical fiber base material set in the glass lathe via a dummy rod connected to an end of the optical fiber base material.

8. The optical fiber base material drawing method according to claim 1, wherein
the heating source flame polishes a surface of the optical fiber base material in the other segment.
